(19) United States
(12) Patent Application Publication
(10) Pub. No.: US 2006/0274623 A1
(43) Pub. Date: Dec. 7, 2006

(54) Flexible write strategy generator

(75) Inventors: Miguel Gabino Perez, Mountain View, CA (US); Theodore D. Rees, Mountain View, CA (US)

Correspondence Address: FLIESLER MEYER, LLP, FOUR EMBARCADERO CENTER, SUITE 400, SAN FRANCISCO, CA, 94111, US

(73) Assignee: Intersil Americas Inc., Milpitas, CA (US)

(21) Appl. No.: 11/446,056

(22) Filed: Jun. 2, 2006

Related U.S. Application Data
(60) Provisional application No. 60/687,225, filed on Jun. 3, 2005.
(60) Provisional application No. 60/700,135, filed on Jul. 18, 2005.

(51) Int. Cl. G11B 7/0045

(52) U.S. Cl. 369/59.11

(57) ABSTRACT

Methods and system are provided that enable unique write strategies to be selected without having to provide custom chips. Specific embodiments allow a user to specify which combinations, of total possible combinations, of space-to-mark lengths and mark-to-space lengths can have unique timing parameters defined in a portion of timing memory dedicated to storing space-to-mark and mark-to-space timing parameters, where unique timing parameters are defined for less than the total possible combinations of space-to-mark lengths and mark-to-space lengths. Embodiments also allow a user to select among different combination of timing mode and modulation code.

### PRIORITY CLAIM

This application claims priority under 35 U.S.C. 119(e) to both U.S. Provisional Patent Application No. 60/700,135, filed Jul. 18, 2005, and U.S. Provisional Patent Application No. 60/687,225, filed Jun. 3, 2005.

### FIELD OF THE INVENTION

The present invention relates to a technology for recording information onto an information recording medium, such as an optical disk.

### BACKGROUND

In the field of products concerning the optical disk such as CD, DVD and the like, there is a tendency to increase both the storage capacity, and the speed of data transfer in order to be competitive and capture market share. Also, with the capacity of the optical disk increased, marks and spaces (corresponding to a representation of the 1s and 0s of information) to be formed on the optical disk are smaller and more precise, and the formation of such fine marks and spaces is required to be more flexible and accurate in the optical disk apparatus.

Factors such as media type, writing speed, disc format and drive optics necessitate particular write strategies, which are used to write the marks and spaces. In general, the writing of marks on a disk can be considered to compose of the first pulse which defines the starting edge of a mark, multipulses which fill the center of a mark, and the last pulse which defines the ending edge of a mark. A key portion of the write strategy is the definition of multipulse locations and timing in response to NRZ input data (or NRZI input data).

Previous write strategy generators were very limited with regards to how multipulses can be defined. For example, for CD and DVD, the minimum mark length is 3T, and longer marks are 4T, 5T, 6T, etc, up to 14T. A 3T mark would be formed with a single pulse which would define both the leading and tailing edges of the 3T mark. The reason only one pulse would be used is that the laser spot size is comparable to the size of the 3T mark itself. A 4T mark would typically be defined by either one large pulse, or two small pulses. A 5T mark would be defined either by two or 3 pulses. If it was composed of three pulses, the center pulse would be a multipulse. A 6T mark would be composed of 3 or 4 pulses, with either 1 or 2 multipulses. A key restriction of early write strategies is that one and only one multipulse could occur for each T interval between the first and last pulses. Thus they were called “1T multipulse strategies”. However, as optical drives increased in speed, the media was not fast enough to respond to a 1T multipulse strategy, nor was there enough time to bring the drive currents up and down in the low nanosecond intervals required to implement the 1T multipulse strategy. Accordingly, a “2T multipulse strategy” began to be used, where a multipulse is placed every other T between a first and last pulse of a mark, with the multipulse pattern optionally being different for even mark-lengths than for odd mark-lengths. However, other “custom” multipulse strategies are sometimes desired, potentially requiring that custom chips be designed, which is typically not cost effective. Accordingly, given the variety of existing and prospective write strategies in the market, it is desirable to provide for greater flexibility in defining multipulses. From a design point of view, efficiency and compactness of the implementation are important considerations.

Other key portions of a write strategy include definitions of the first pulse and last pulse in response to NRZ input data, as well as the modulation code that is used. The modulation code for CD and DVD typically used Eight to Fourteen modulation (EFM), or enhanced EFM, both of which have marks of 3T, 4T, etc. But Blue recording media typically uses a 17PP ((RLL(1,7) with Parity preserve/Prohibit RMTR) modulation code which has marks of 2T, 3T, 4T, etc. The 17PP code is sometime referred to as a 1-7 code. As mentioned earlier, there is also desire for some flexibility in choosing when and how many multipulses to fit within a given mark as well.

In addition to this, there is an issue that has to do with the influence of size of the spaces surrounding a mark to the strategy itself. For instance, if a mark is preceded by a 3T space, the optical and thermal history before the first pulse would dictate that the position of the first pulse be changed depending on both the size of the mark, and the size of the preceding space. Likewise, the timing of the last pulse would be influenced by the size of the mark and the following space. This led to an array of programmable pulse start and duration times for the first and last pulses. Ideally, the array would cover all mark and space sizes from 2T through 14T. But in practice, this requires excessive programming space and time. So the array is typically shortened to a 4×4 array that includes 3Tm, 4Tm, 5Tm, 6Tm, and the corresponding 3Ts, 3Ts, 4Ts, and 5Ts, where Tm means length of a mark in T's, and Ts means length of a space in T's. However, this 4×4 array was not always desired by a customer, which may result in a custom chip being designed. Accordingly, it would be useful if the array arrangement were more flexible, thereby not requiring a new design each time a customer wanted to redefine the array.

Typically, a write strategy generator will only offer one or two combinations of such modulation codes and timing modes, as well as only one way of organizing data that defines parameters such as the first and last pulse of a mark. Again, greater flexibility in selecting combinations of modulation codes and timing modes, as well as in organizing the data that defines write strategy parameters (such as first and last pulse of a mark) is desirable, to thereby reduce the need for custom chips. From a design point of view, efficiency and compactness of the implementation are again important considerations.

### SUMMARY OF INVENTION

Embodiments of the present invention are directed to laser driver systems that provides flexible multipulse strategies. Such a laser driver system can include a mark/space detector, a sequencer and a plurality of multipulse location registers. The mark/space detector is configured to detect mark-lengths and space-lengths in an NRZ signal, and to provide such information to the sequencer. In accordance with a specific embodiment, the plurality of multipulse location registers are dedicated to storing multipulse location information, wherein each of a plurality of different mark-lengths that can result in at least one multipulse location has a multipulse location register that defines the position of it's multipulses. Each bit location within the multipulse location registers can contain a first type of bit (e.g., a “1”) or a second type of bit (e.g., a “0”), wherein the first type of bit indicates where to execute a multipulse, and the second type of bit indicates where to not execute a multipulse.

In accordance with embodiments of the present invention, timing memory stores TSMP (time start of multipulse) and TEMP (time end of multipulse) parameters. These parameters define the timing of the rising and falling edges of the multipulses. Unique TSMP and TEMP parameters may be stored, within the timing memory, for each of the plurality of different mark-lengths that can result in at least one multipulse. However due to the many different possibilities, only a few TSMP and TEMP values are used for all of the various multipulses to reduce complexity and cost, in accordance with an embodiment.

In response to receiving information indicative of a mark-length from the mark/space detector, the sequencer accesses one or more bit location within the multipulse location registers, in order to implement the multipulse execution strategy that corresponds to the mark-length. The sequencer also accesses the timing memory in order to determine the TSMP and TEMP timing parameters that correspond to the mark-length.

In accordance with specific embodiments of the present invention, a portion of the timing memory is dedicated to storing space-to-mark and mark-to-space event parameters that define a first pulse and a last pulse of a mark. (An event is defined as a change in the write current, which occurs when the timer executes the timing of the timing parameter. The term event is used because both a timing parameter is executed, and a write current parameter is executed simultaneously.) Specific embodiments of the present invention allow a user to specify which combinations, of total possible combinations, of space-to-mark lengths and mark-to-space lengths can have unique timing parameters defined in the portion of timing memory dedicated to storing space-to-mark and mark-to-space timing parameters, where unique timing parameters are defined for less than the total possible combinations of space-to-mark lengths and mark-to-space lengths. In accordance with one embodiment, this is accomplished using a write strategy control register(a) that includes a plurality of bits that are used to specify how the aforementioned portion of timing memory is organized. For example, this portion of timing memory can be organized as 4 mark by 4 space (4×4), 5 mark by 3 space (5×3) and mark-length-only arrays, wherein the bits within the write strategy control register can be used to select among the arrays.

The write strategy control register can also include at least one bit that is used to specify either a mode-A or a mode-B timing mode. In mode-A, a first multipulse location begins on the 1st T of a mark, and in mode-B a first multipulse begins on the 2nd T of a mark. The mode-A timing makes it easier to have one more multi-pulse between the first and last pulse, than the mode-B timing. Additionally, the write strategy control register can also include at least one bit that is used to specify one of at least two modulation codes.

In accordance with specific embodiments of the present invention, the write strategy control register enables a selection of different combinations of timing memory organization, timing mode and modulation code. In other words, the write strategy control register enables a selection of one of at least two different ways in which timing memory is organized, whether a first multipulse location begins on the 1st T of a mark or on the 2nd T of a mark, and whether a first or a second modulation code is used when writing.

Further embodiments, and the features, aspects, and advantages of the present invention will become more apparent from the detailed description set forth below, the drawings and the claims.

### BRIEF DESCRIPTION OF THE DRAWINGS

FIG. 1 is a high level diagram of an exemplary laser driver.

FIG. 2 is a high level diagram showing a write strategy generator of the laser driver shown in FIG. 1.

FIG. 3A is a diagram showing exemplary drive waveforms for a mark-length of 11T, which may be generated by a laser driver.

FIG. 3B is a diagram showing how bits (B7-B0) in one of the registers shown in FIG. 2 can be used to specify on which T positions to execute multipulses for a mark-length of 11T, in accordance with an embodiment of the present invention.

FIGS. 4A and 4B illustrate two different ways in which the registers shown in FIG. 2 can be mapped for the purpose of indicating on which T positions to execute multipulses, for various mark lengths, in accordance with an embodiment of the present invention. Other bit arrangements are possible.

FIGS. 5A and 5B illustrate two different ways in which the timing memory shown in FIG. 2 could be defined for different TSMP (time start multipulse) and TEMP (time end multipulse) for each mark-length of 4T or greater, or for different subgroups of mark-lengths of 4T or greater.

FIG. 6 illustrates an exemplary write strategy control register, according to an embodiment of the present invention.

FIG. 7 is useful for explaining how bits [2:0] of the write strategy control register shown in FIG. 6 can be used to select one of a plurality of different arrangements (arrays) in which space-to-mark and mark-to-space parameters can be arranged, according to an embodiment.

FIG. 8A illustrates an exemplary 4×4 array with EFM code for space-to-mark parameters (TSFP, TEFP, TMFP and TEER).

FIG. 8B illustrates an exemplary 4'4 array with EFM code for mark-to-space parameters (TSLP, TELP, TEMPP and TECP).

FIG. 9A illustrates an exemplary 4×4 array with 17PP code for space-to-mark parameters (TSFP, TEFP, TMFP and TEER).

FIG. 9B illustrates an exemplary 4×4 array with 17PP code for mark-to-space parameters (TSLP, TELP, TEMPP and TECP).

FIG. 10A illustrates an exemplary 5×3 array with EFM code for space-to-mark parameters (TSFP, TEFP, TMFP and TEER).

FIG. 10B illustrates an exemplary 5×3 array with EFM code for mark-to-space parameters (TSLP, TELP, TEMPP and TECP).

FIG. 11A illustrates an exemplary 5×3 array with 17PP code for space-to-mark parameters (TSFP, TEFP, TMFP and TEER).

FIG. 11B illustrates an exemplary 5×3 array with 17PP code for mark-to-space parameters (TSLP, TELP, TEMPP and TECP).

FIG. 12A illustrates an exemplary mark-length-only array with EFM code for space-to-mark parameters (TSFP, TEFP, TMFP and TEER).

FIG. 12B illustrates an exemplary mark-length-only array with EFM code for mark-to-space parameters (TSLP, TELP, TEMPP and TECP).

FIG. 13A illustrates an exemplary mark-length-only array with 17PP code for space-to-mark parameters (TSFP, TEFP, TMFP and TEER).

FIG. 13B illustrates an exemplary mark-length-only array with 17PP code and for mark-to-space parameters (TSLP, TELP, TEMPP and TECP).

### DETAILED DESCRIPTION

Embodiments of the present invention relate to recordable optical disk drives, and in particular to laser driver integrated circuits for controlling pulse-segmented laser drive waveforms of multi-valued levels, or more in particular to laser driver integrated circuits and optical disk drives with a laser driver integrated circuit mounted thereon, in which the operation can be switched at high speed and high accuracy in keeping with various drive waveforms.

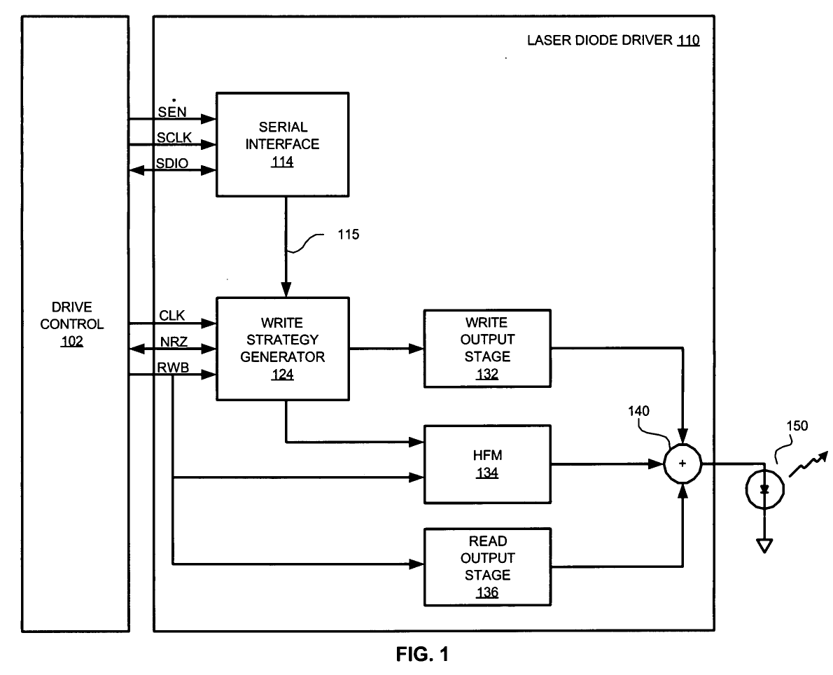

FIG. 1 is a high level diagram showing a laser driver 110 of a data storage device in communications with a drive controller 102 (e.g., a host). The data storage device can be, for example, an optical storage device that includes an optical disk upon which user data can be stored. The laser driver 110 drives a laser diode 150 in order to read data from, and write data to, the optical disk. In the exemplary environment shown, the laser driver 110 is shown as including a write strategy generator 124 and a serial interface 114 that can provide write strategy information 115 (e.g., updates) to the write strategy generator 124. In accordance with specific embodiments of the present invention, the drive controller 102 can provide write strategy updates to the laser driver 110, via the serial interface 114, and such updates can be used to update registers and memory within the write strategy generator 124.

The laser driver 110 is also shown as including a write output stage 132, a high frequency modulation (HFM) circuit 134 and a read output stage 136, the outputs of which are added by a summer 140. The summer can simply be the hard wiring of the three currents, but other summers are also possible. The write output stage 132 includes at least one write digital-to-analog converter (DAC), and other circuitry used to convert the digital output of the write strategy generator 124 to an analog write signal. The HFM circuit 134 is used to provide a high frequency current to the laser diode 150 during reading. The read output stage 136 includes at least one DAC that converts a digital read signal to an analog read signal.

The drive controller 102 is shown as providing a serial enable (SEN) signal and a serial clock (SCLK) signal to the serial interface 114 of the laser driver 110. Additionally, a bi-directional serial data input/output (SDIO) line allows the drive controller 102 to write data to and read data from registers or memory locations within the laser driver 110. For example, write strategy updates can be provided over the SDIO line. The drive controller 102 is also shown as providing a data clock (CLK) and a read write direction signal (RWB) to the laser driver 110. For example, a LOW RWB signal can designate WRITE, and a HIGH RWB signal can designate READ, or vice versa. A data line is labeled NRZ (Non-Return-to-Zero). The communications between the drive controller 102 and laser driver 110 are likely to occur over a flexible cable, also known as a flex cable.

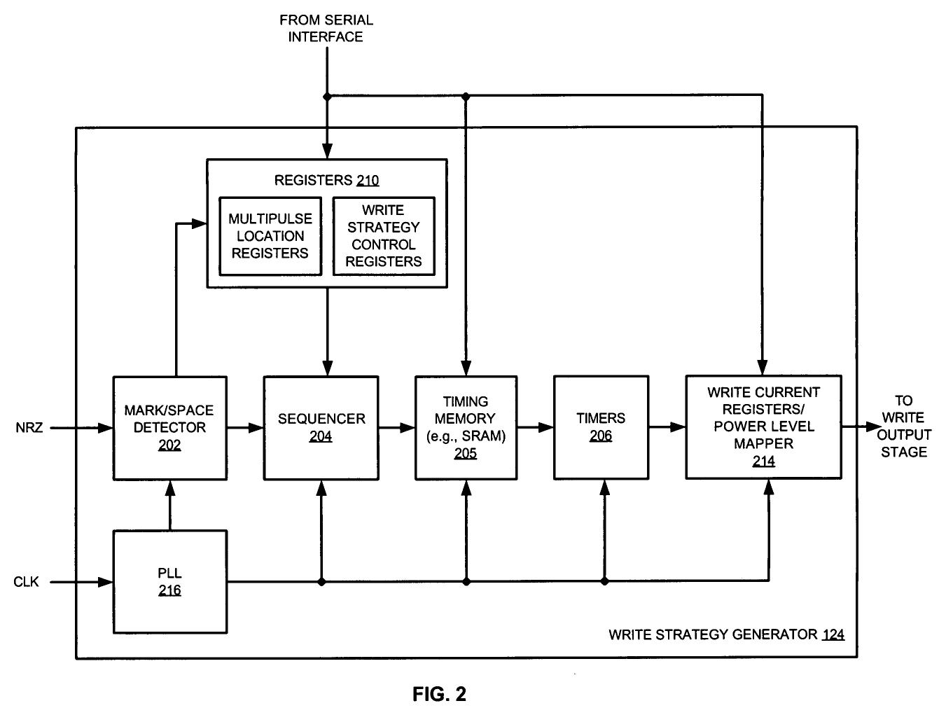

Referring now to FIG. 2, the write strategy generator 124 is shown as including a mark/space detector 202, a sequencer 204, timing memory 205, timers 206, registers 210 and write current registers 214. The mark/space detector 202 detects mark-lengths and space lengths from the NRZ or NRZI signal (collectively referred to hereafter as an NRZ signal). The sequencer 204, e.g., implemented by a microprocessor, state machine, etc., schedules output power transitions relative to the mark-space positions in accordance with a write strategy mode that is selected. Exemplary write strategy modes, which are not meant to be limiting, include: mode-A, mode-B, CD-2T, 17PP Blue Ray, and 17PP with 2T. One of the plurality of different write strategy modes can be selected using the control registers 210, as will be describe in more detail below. The timing of each power transition edge is provided by timers 206, which are controlled via timing memory 205. There may be more than one timer 206 (e.g., there may be four timers). Additionally, the write current registers 214 store write current levels for each possible event. Such write current registers 214, which may also be referred to hereafter as event power registers, may include land and groove registers, for example. The registers 210 include multipulse location registers and control/status registers. The timing memory 205 can specify a time delay of each timer 206 for each type of space-mark-space sequence. The contents of registers 210 and 214, and of the timing memory 205, can be modified using the serial interface 114, as mentioned above.

The timers 206, which are used to produce mark-space edges on the optical disk surfaces of the storage device, lie dormant until started. The sequencer 204 accesses timing memory 205, which feeds and starts the timers 206 at the appropriate time references to the mark-space edges. Each possible event, such as Time Start First Pulse (TSFP), Time End First Pulse (TEFP), etc., is defined to have a timing component and a power or amplitude component. The sequencer 204 queues events at appropriate intervals to generate desired write strategy waveforms. The timers 206 control when a queued event actually occurs. The sequencer 204 accesses the timing memory 205 to load the timers 206 upon receiving specific NRZ data stimulus. After the timer counts down to zero, the write current registers 214 are triggered to output an appropriate write current value. In general, during a mark section, the laser power is modulated to produce pulses (including multipulses) that are used for driving the laser diode 150. While in a space section, a laser diode 150 is driven with the power (smaller than the power for mark recording) for erasing the mark and space previously recorded in the medium. But this is completely determined by the programming.

Flexible Multipulse

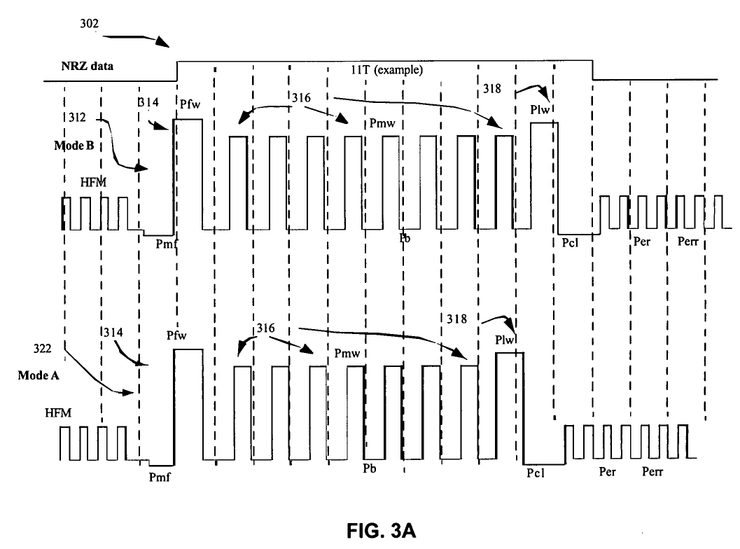

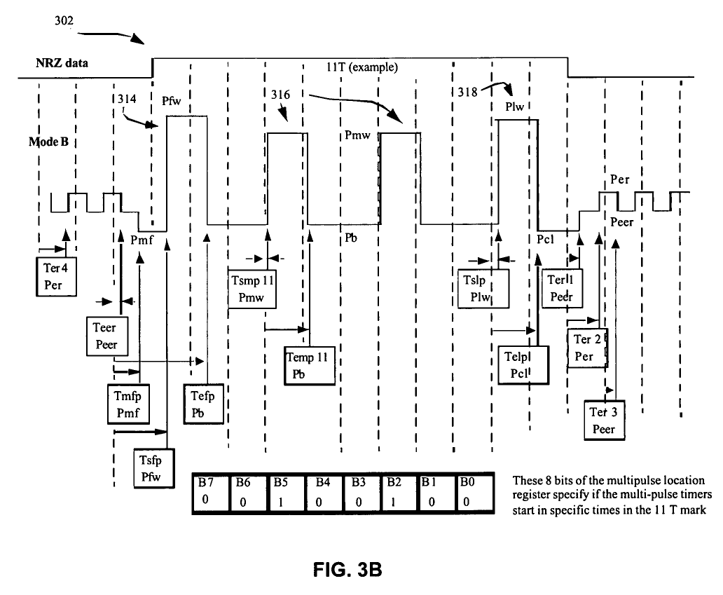

FIG. 3A is a diagram showing exemplary drive waveforms for a mark-length of 11T, where T is defined as a minimum unit for determining the mark and space lengths and corresponds, e.g., to the period of a so-called channel clock (chCLK). More specifically, at the top of FIG. 3A is an NRZ data signal 302 that is high for 11T. A first exemplary drive signal 312 generated in response to the NRZ signal 302 is shown as including a first pulse 314, a last pulse 318, and eight multipulses 316 therebetween. As can be appreciated from FIG. 3A, the multipulses are the middle pulses of a laser drive waveform, issued between the first pulse and last pulse of a mark. Great flexibility in defining multipulses is a compelling feature of a write-strategy laser driver, given the variety of existing and prospective write strategies on the market. Specifically as the T period decreases in time, the ability of the laser driver and media to respond to the short pulses is compromised, and it is desirable to fill the interval between the first and last pulses with fewer middle pulses.

In the example shown, the mark formation begins with a cooling pulse Pmf, followed with the first pulse Pfw. This is sometimes done to increase the thermal gradient at the leading edge of the mark. The last pulse has an amplitude Plw (last write power) and is followed by Pcl, another cooling pulse to increase the thermal gradient at the tailing edge of the mark . The multipulses 316 have an amplitude corresponding to Pmw (multipulse write power). A second exemplary drive signal 322 is similar to the drive signal 312, except that signal 312 is a mode-B signal, and signal 322 is a mode-A signal. The difference between mode A and mode B is that it is easier to have an extra multi-pulse in mode B because the last pulse timer starts later in mode B than in mode A.

In accordance with an embodiment (in mode A or mode B), the number of possible multipulses is equal to the mark-length minus three or four. Thus, for a mark-length of 11T (as in this example), there can be either 7 or 8 multipulses; for a mark-length of 10T, there can be 6 or 7 multipulses; . . . and for a mark-length of three or less, there are no multipulses.

As mentioned above, previous write strategy generators were very limited with regards to how multipulses could be defined. However, other “custom” multipulse strategies were sometimes desired, leading to the design of “custom” chips, which is typically not cost effective. Accordingly, to avoid the requirement for custom chips, specific embodiments of the present invention were developed, to allow for numerous unique multipulse strategies using a common chip, as will be explained below. Because of their flexibility, such embodiments of the present invention will sometimes be referred to as flexible multipulse strategies.

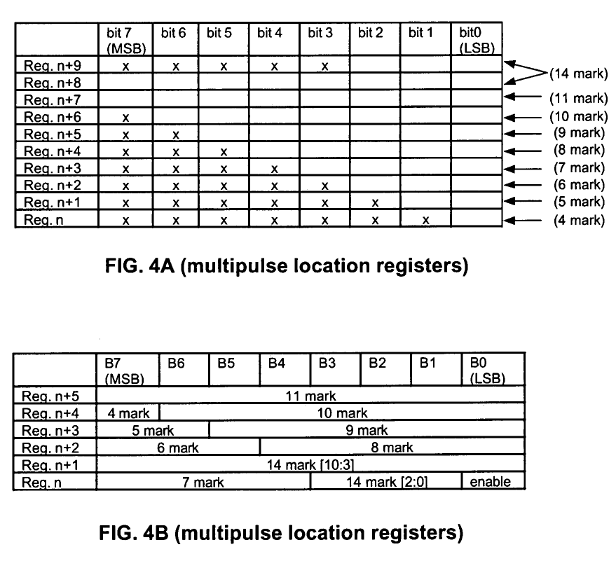

In accordance with specific embodiments of the present invention, a flexible multipulse strategy is implemented using a set of registers that are mapped such that at least N−3 register bits (were N is the mark-length) are associated with each possible mark-length, for the purpose of indicating on which T positions to execute multipulses for the mark-length. (T is a minimum unit time of change of the binary recording signal NRZ and corresponds, e.g., to a period of the clock CLK. For example, 8 register bits are associated with an 11T mark for the purpose of indicating on which of 8T positions to execute a multipulse when writing an 11T mark. For another example, 7 register bits are associated with a 10T mark for the purpose of indicating on which 7T positions to execute a multipulse when writing a 10T mark. For a 4T mark, 1 register bit is used to indicate whether to execute a multipulse on 1T position when writing the 4T mark. For a mark-length of less than 4T, no registers are needed for this purpose. In accordance with specific embodiments of the present invention, a “1” within a register bit indicates on which T positions to execute a multipulse within a mark, and a “0” indicates on which T positions to not execute a multipulse within the mark (however, it is also within the scope of the present invention that a “0” indicates where to execute a multipulse, and a “1” indicates where to not execute a multipulse). This will now be explained with reference to FIGS. 3B, 4A and 4B.

FIG. 3B is a diagram showing a different exemplary drive waveforms for a mark-length of 11T. In this example, multipulses are executed in only two of the eight possible positions. Also shown in FIG. 3B are the 8 bits (B7-0) that are used to indicate where to execute a multipulse, with a “1” within a register bit indicating on which T positions to execute a multipulse within the 11T mark, and a “0” indicating on which T positions to not execute a multipulse within the mark. Also shown in FIG. 3B, are two timing events that change laser power, including time start of multipulse (TSMP) and time end of multipulse (TEMP), which in accordance with embodiments of the present invention can be defined as a function of mark-length. In other words, when a multipulse location bit is 1, two timers start. Different multipulse timing for different mark-lengths can be specified through various start and end multipulse parameters, which are defined in timing memory 205, as will be appreciated from the discussion below.

FIG. 4A shows ten 8-bit registers (labeled Reg. n to Reg. n+9) that can be used to for the purpose of indicating on which T positions to execute a multipulse for mark-lengths 4T to 11T and 14T (or 12T+). The “x”s in the registers indicate “don't cares.” FIG. 4B shows an arrangement where the “don't cares” can be eliminated, such that only six 8-bit registers are used for the purpose of indicating on which T positions to execute a multipulse for mark-lengths 4T to 11T and 14T, in accordance with an embodiment of the present invention. Other bit arrangements are also possible.

Referring to FIG. 4A, in accordance with an embodiment of the present invention, if there is a “1” located in least significant bit (LSB) of register n, then timers TSMP and TEMP will start. As was mentioned above in the discussion of FIGS. 3A and 3B, if mode-A is being used the multipulse timers TSMP and TEMP will begin on the 1st T of the mark, and if mode-B is being used the multipulse timers TSMP and TEMP will begin on the 2nd T of the mark. In a specific embodiment, if TSMP and TEMP are properly programmed, then a multipulse will occur after the first pulse, and before the last pulse. (As will be described in more detail below, flexible write strategies of the present invention allow for the selection of either mode-A or mode-B.) If there is a “0” located in the LSB of register n, then the timers will not start, and there will no multipulse. Referring now to FIG. 4B, in this embodiment it is the most significant bit (MSB) of register n+4 that is used to specify whether or not the multipulse timers TSMP and TEMP will start as mentioned for mode A or mode B.

Referring again to FIG. 4A, it can be seen that the four least significant bits (B0, B1, B2 and B3) of register n+3 are used to specify where multipulses are located for a 7T mark. As was explained above, for a 7T mark, there are four positions in which multipulses may be located. In the prior art “1T multipulse strategy”, for a 7T mark there could be three or four multipulses, one in each of the available positions between the first and last pulse of the 7T mark. In the prior art “2T multipulse strategy” there would be two multipulses, one in every other position between the first and last pulse of the 7T mark. In contrast, using the present invention, there are sixteen different multipulse strategies that can be defined for a 7T mark (i.e., 0000, 0001, 0010, 0011, 0100, 0101, 0110, 0111, 1000, 1001, 1010, 1011, 1100, 1101, 1110, 1111). Referring to FIG. 4B, in this embodiment it is the four MSBs (B7, B6, B5 and B4) of register n that are used to specify one of the sixteen possible multipulse strategies for a 7T mark. Thus, it can be appreciated how embodiments of the present invention can be used to define numerous different multipulse strategies. More specifically, where there are n possible locations for a multipulse, embodiments of the present invention allow at least 2ˆn different multipulse strategies to be defined. Thus, for another example, for an 8T mark, where there are 5 possible locations for a multipulse (i.e., 8−3=5), there are at least 32 different multipulse strategies that can be defined using embodiments of the present invention (i.e., 2ˆ5=32).

In the tables of FIGS. 4A and 4B, the MSB of each mark-length represent the first available multipulse position, while the LSB is the last available multipulse position in the mark. This can be reversed if desired. FIGS. 4A and 4B illustrate two ways in which multipulse strategies can be mapped to register locations, in accordance with embodiments of the present invention. However, one of ordinary skill in the art will appreciate from the description above that other mappings are also within the spirit and scope of the present invention.

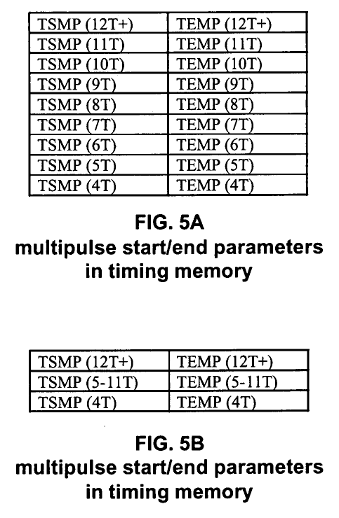

As mentioned above, timing memory 205 can be used to define parameters that specify the start and end of each multipulse, i.e., TSMP (time start multipulse) and TEMP (time end multipulse). Previous write strategy generators were very limited with regards to how TSMP and TEMP parameters could be defined. More specifically, it is believed that previous write strategy generators only allowed a single TSMP and a single TEMP to be defined for all possible mark lengths, or at most two sets: one for even mark lengths and one for odd mark lengths. Also, previous write strategy generators may have also allowed differences between first, second, and subsequent multipulses within a mark, but again with no variation possible for different mark lengths. To provide more flexibility, in accordance with embodiments of the present invention, there can be a different TSMP parameter and TEMP parameter for each mark-length that may include a multipulse (e.g., for each mark length of 4T or more). This can be implemented, e.g., by storing in timing memory 205 a TSMP parameter and a TEMP parameter for each mark-length that may include a multipulse, as can be appreciated from FIG. 5A. More specifically, FIG. 5A shows eighteen 8-bit memory locations, nine of which are used to store TSMP parameters for the nine different mark-lengths that can include multipulses (e.g., 4T, 5T, 6T, 7T, 8T, 9T, 10T, 11T and 12T+) and nine of which are used to store TEMP parameters for the nine different mark-lengths that can include multipulses. In another embodiment, there can be unique TSMP and TEMP parameters for mark-length 4T (the shortest mark-length that can include a multipulse); common TSMP and TEMP parameters for mark-lengths between 5T and 11T, inclusive; and further unique TSMP and TEMP parameters for mark-lengths of 12T or more, as is shown in FIG. 5B.

Other multipulse parameters besides TSMP and TEMP may also be defined such that there are unique parameters defined for the different mark-lengths that can include multipulses. Accordingly, additional timing memory 205 can be used to define such other multipulse parameters.

Referring back to FIG. 2, in operation, an NRZ signal is provided to the mark/space detector 202 (e.g., from the host 102), and the mark/space detector 202 detects the length of each mark and space, and provides such information to the sequencer 204. The sequencer 204 uses the mark-to-space and space-to-mark information to access the timing memory 205 that define the first and the last pulse of a mark, as will be described in more detail below, as well as the start and end of each multipulse therebetween, if any. The sequencer 204 also uses the mark-length information to accesses the multipulse location registers (of registers 210) that define location(s) of the multipulse(s) for the detected mark-length. Based upon the mark-to-space or space-to-mark lengths detected by the detector 202, appropriate contents of the timing memory 205 are loaded into the timers 206, which then begin a count down. After a timer 206 counts down to zero, the write current registers 214 output a power level corresponding to the event. The timers 206 can count to fractions of a ChCLK interval, to provide fine control over output waveform timing.

As was explained above, in accordance with embodiments of the present invention, the possible mark-lengths for EFM code that can have a multi-pulse are from 4 to 11 marks, and 12+ marks. One of ordinary skill in the art will appreciate that it is possible to include other specific mark-lengths, or to define additional time events for a multipulse, if desired.

Flexible Write Strategies

In addition to providing for flexible multipulse strategies, embodiments of the present invention also more generally allow for flexible write strategies. As mentioned above, factors such as media type, writing speed, disc format and drive optics necessitate particular write strategies. A key portion of the write strategy is the definition of multipulse location and timing in response to NRZ input data, as was discussed above. Other key portions of the write strategy are defining parameters for the first pulse 314 and last pulse 318 of a drive waveform (see FIGS. 3A and B). Embodiments of the present invention, as will be described below, also allow for the selection of different combinations of modulation codes, timing modes (e.g., mode-A or mode-B), and mark-to space and space-to-mark parameter arrays. Such selections can be performed by a user via the serial interface 114 (FIG. 1), which, through signal bus 115, can update the contents of the registers 210 (FIG. 2) and 215 and timing memory 205 of the write strategy generator 124.

Exemplary parameters for defining the first pulse of a mark include timing and power parameters for each of the following space-to-mark events: TSFP (time start first pulse); TEFP (time end first pulse); TMFP (time middle first pulse); and TEER (time end erase pulse). Power parameters that correspond to these timing events are, respectively: Pfw (first write power); Pb (bias power); Pmfw (middle first write power); and Peer (end erase power). The timing parameters are stored in timing memory 205, and the power parameters are stored in write current registers 214.

Exemplary parameters for defining the last pulse mark including timing and power parameters for each of the following mark-to-space parameters: TSLP (time start last pulse); TELP (time end last pulse); TEMPP (time end multipulse programmable); and TECP (time end cooling pulse). Power parameters that correspond to these timing events are, respectively: Plw (last write power); Pcl (cool power); Per (erase power); and Pb (bias power).

In accordance with embodiments of the present invention, certain write strategy parameters (including the above mentioned space-to-mark and mark-to-space parameters) are arranged in arrays, examples of which include a 4×4 array, a 5×3 array, and a “use mark-length-only” array. The overall size of such arrays is limited by the amount of timing memory 205 that is dedicated to storing space-to-mark and mark-to-space event parameters. For example, it may be that the timing memory 205 includes a total of 128 8-bit locations that are dedicated to storing these particular write strategy events, with 64 of the 8-bit locations dedicated to the space-to-mark events, and the other 64 of the 8-bit locations dedicated to the mark-to-space events. It may also be that each timing event parameter takes up 8-bits (1 byte). In other words, assume the four space-to-mark parameters TSFP, TEFP, TMFP and TEER can be stored in 32-bits (i.e., 4 bytes) and the four mark-to-space parameters TSLP, TELP, TEMPP and TECP can be stored in another 32-bits (i.e. another 4 bytes). Thus, if 64 8-bit locations (i.e., 64 1 byte locations) are dedicated to storing the space-to-mark parameters TSFP, TEFP, TMFP and TEER, and each group of these four parameters takes up 4 bytes, then up to 16 different TSFP, TEFP, TMFP and TEER parameters can be stored. Similarly, if 64 8-bit locations (i.e., 64 1 byte registers) are dedicated to storing the mark-to-space TSLP, TELP, TEMPP and TECP, and each group of these four parameters takes up 4 bytes, then up to 16 different TSLP, TELP, TEMPP and TECP parameters can be stored. As will be understood from the discussion below, embodiments of the present invention provide for greater flexibility of how such parameters can be organized or arranged within the memory space allotted.

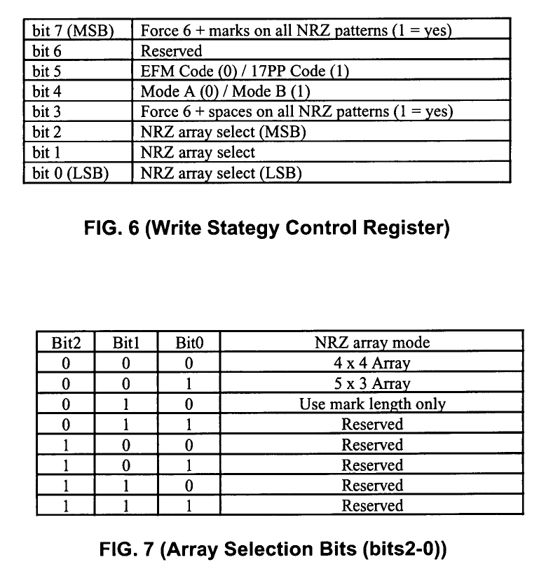

In accordance with an embodiment of the present invention, a multi-bit (e.g., 8-bit) write strategy control register enables independent selection of timing modes (e.g., mode-A or mode-B), parameter organization (e.g., 4×4 array, 3×5 array, or mark-length-only based list), and modulation codes (e.g., 17PP or EFM). An exemplary write strategy control register is shown in FIG. 6, where:

Bit7 HI (i.e., 1) reduces the size of the parameter arrays by setting the mark-length=6+Marks if using EFM code, or 5+Marks if using 17PP code. In other words, if this bit is set, all marks are treated as if they are long marks. This can be used together with Bit3 to further reduce the parameter choices. It does not affect odd/even detection if a 5×3 array is used. It should be set LO (i.e., 0) if using only mark-length based parameters, for it will interfere with proper mark-length detection.

Bit6 is not used in this example.

Bit5 HI will use 17PP codes for the write strategy. Bit5 LO will use EFM codes for the write strategy.

Bit4 HI sets the timing to mode-B (a 1T gap between the first pulse and the start of multipulsing, and the last pulse timer starts 2T before the end of the mark). Bit4 LO uses mode-A (no gap between first pulse and the start of multipulsing, and the last pulse timer starts 3T before the end of the mark).

Bit3 HI reduces the size of the parameter arrays by setting the space length=6+Spaces if using 2-7 code, or 5+Spaces if using 17PP code. In other words, if this bit is set, all spaces are treated as if they are long spaces. This can be used together with Bit7 to further reduce the parameter choices. It does not affect odd/even detection if a 5×3 array is used. It has no effect when using mark-length based parameters.

Bits2-0 define how the parameters will be arranged depending on the Mark/Space combinations, as discussed below with reference to FIG. 7.

As just mentioned, certain bits of the write strategy control register of FIG. 6 are used to define how write strategy parameters are arranged. In a specific example, the three least significant bits (Bits2-0) of the write strategy control register are used for this purpose. However, it is possible to use more or less bits and alternative bit locations (e.g., the three MSBs) to specify how specific write strategy parameters are organized.

Referring to FIG. 7, since in this example there are three bits that are used to define how write strategy parameters are arranged, then there can be up to eight different arrangements (i.e., 2ˆ3=8). However, in the example shown in FIG. 7, only 3 of the 8 possible bit combinations are used to define write strategy parameter arrangements, while the other 5 bit combinations are shown as being “reserved”. However, this need not be the case. Other arrays can also be used, such as an 8×2 array, a “use-space-length-only” array, etc. In addition, bit 7 and bit 3 can serve to collapse the arrays to 4×1 or 1×4 arrays or 5×1 or 1×3 arrays. So they could have been encoded within bits 2-0.

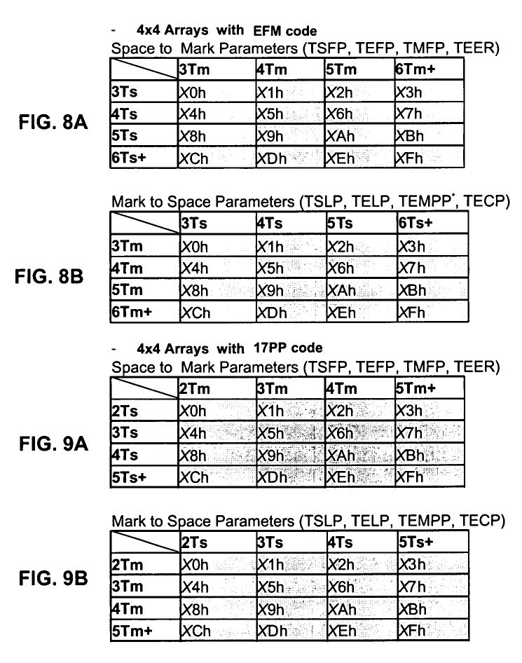

An exemplary 4×4 array with EFM code for space-to-mark parameters (TSFP, TEFP, TMFP and TEER) is shown in FIG. 8A, and for mark-to-space parameters (TSLP, TELP, TEMPP and TECP) is shown in FIG. 8B. An exemplary 4×4 array with 17PP code for space-to-mark parameters is shown in FIG. 9A, and for mark-to space-parameters is shown in FIG. 9B. The hexadecimal numbers in the arrays (with X being a variable) are used to represent only the first (or last) nibble of the serial memory address. Accordingly, FIGS. 8A, 8B, 9A and 9B illustrate that, in accordance with embodiments of the present invention, a set of space-to-mark parameters (FIG. 8A) and a set of mark-to-space parameters (FIG. 8B) can be stored for one type of modulation code that can be used (e.g., EFM), while separate sets of space-to-mark (FIG. 9A) and mark-to-space parameters (FIG. 9B) can be stored for a different modulation code that can be used (e.g., 17PP). Alternatively, the same memory addresses are shared for the different modulation codes (e.g., EFM, 17PP, etc.) and the user reprograms these registers according to the code they want to use.

The variable “X” is used to avoid listing a different table for each parameter. For example, TSFP could encompass addresses 70h-7Fh, TEFP could encompass 60h-6Fh, etc. To avoid listing all these possibilities (i.e., for convenience), a single array is listed for all mark-space and space-mark parameters using X0-XFh. As was explained above with reference to FIG. 6, a bit within the write strategy control register can be set to indicate which modulation code is to be implemented (e.g., 2-7 or 17PP EFM).

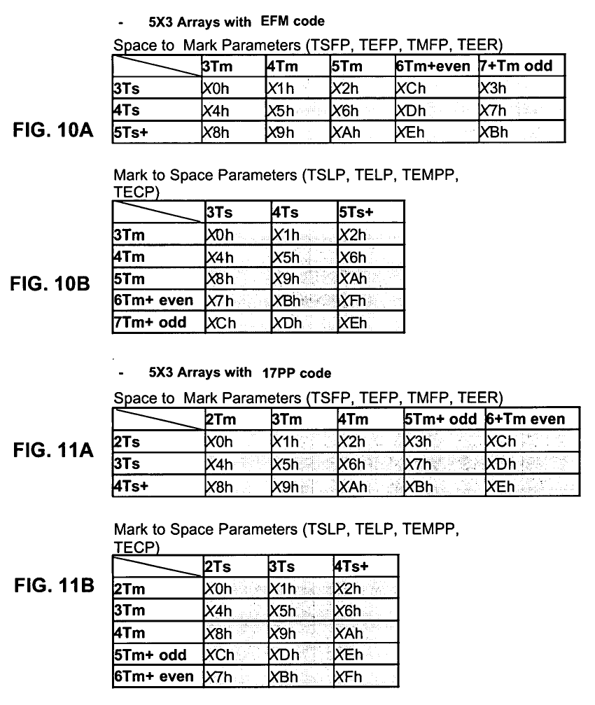

An exemplary 5×3 array with EFM code for space-to-mark parameters is shown in FIG. 10A, and for mark-to-space parameters is shown in FIG. 10B. An exemplary 5×3 array with 17PP code for space-to-mark parameters is shown in FIG. 11A, and for mark-to-space parameters is shown in FIG. 11B. A comparison of FIGS. 10A, 10B, 11A and 11B to FIGS. 8A, 8B, 9A and 9B illustrates that that space-to-mark and mark-to-space parameters can be organized in different manners (different arrays), as selected by the user. As was explained above with reference to FIGS. 6 and 7, bits of the write strategy control register can be set to indicate which organization (array) of parameters is to be implemented (e.g., 4×4 array, or 5×3 array). Since some of the same mark-space combinations can be covered with each organization, a reason for using different organizations is to conserve memory, and make the memory organization easier for the user to understand.

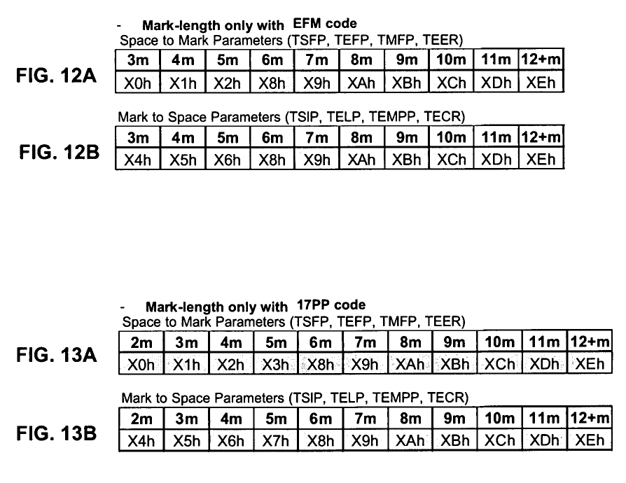

Another possible arrangement of space-to-mark and mark-to-space parameters is illustrated in FIGS. 11A, 11B, 12A and 12B. More specifically, an exemplary mark-length-only with EFM code for space-to-mark parameters (TSFP, TEFP, TMFP and TEER) is shown in FIG. 12A, and for mark-to-space parameters (TSLP, TELP, TEMPP and TECP) is shown in FIG. 12B. An exemplary mark-length-only array with 17PP code for space-to-mark parameters is shown in FIG. 13A, and for mark-to-space parameters is shown in FIG. 13B.

Referring again back to FIGS. 6 and 7, the 3 least significant bits of the mode control register can be set to specify how write strategy parameters are to be arranged. For example, if Bits2-0 are “000” then they will be arranged in a 4×4 array, if Bits2-0 are “001” then they will be arranged in a 5×3 array, and if Bits2-0 are “010” then they will be arranged in a “use mark-length-only” array. As mentioned above, other arrangements are also possible, and within the spirit and scope of the present invention. It is also possible that additional and/or different space-to-mark parameters and mark-to-space parameters than those discussed above can be defined in these arrays.

Referring again to FIG. 2, when the NRZ signal is provided to the mark/space detector 202 (e.g., from the host 102), the mark/space detector 202 detects the length of each mark and space, and provides such information to the sequencer 204. The sequencer 204 uses the mark and space length information to access specific locations of the registers 210 that define the first and the last pulse of a mark. As was previously explained in detail, the sequencer also use mark length information to access registers that define the multipulses (if any) that are to be included between the first and last pulses. As just explained above, the mark-to-space and space-to-mark parameters can be arranged within the timing memory 205 in one of a plurality of different ways (e.g., 4×4, 5×3 or mark-length-only arrays), one of which is selected or specified in the write strategy control register. The sequencer 204 loads the timers 206 with timing parameters such as TSFP, TEFP, TMFP, TEER, TSLP, TELP, TEMPP or TECP and starts the timers upon receiving a proper stimulus. After a counter counts down to zero, the write current registers 214 output an appropriate power level.

In summary, a portion of timing memory 205 is dedicated to storing space-to-mark and mark-to-space event parameters that define a first pulse and a last pulse of a mark. A write strategy control register includes a plurality of bits that are used to specify how this portion of timing memory 205 is organized. For example, the memory can be organized as 4×4, 5×3 and mark-length-only arrays, wherein the bits within the write strategy control register can be used to select among the arrays. The write strategy control register also includes at least one bit that is used to specify either a mode-A or a mode-B timing mode. In mode-A, a first multipulse location begins on the 1st T of a mark and the last pulse timers begin 3T before the end of the mark, and in mode-B a first multipulse begins on the 2nd T of a mark and the last pulse timers begin 2T before the end of the mark. Additionally, the write strategy control register also includes at least one bit that is used to specify either a EFM or a 17PP EFM modulation code. The write strategy control register enables a selection of different combinations of event registers organization, timing mode and modulation code. In other words, the write strategy control register enables a selection of one of at least two different ways in which timing memory is organized, whether a first multipulse location begins on the 1st T of a mark or on the 2nd T of a mark, and whether a first or a second modulation code is used when writing.

As can be appreciated from FIGS. 8-13, by specifying how a portion of timing memory 205 is organized (e.g., as 4×4, 5×3 and mark-length-only array), a user can specify which different combinations of space-to-mark lengths and mark-to-space lengths may have unique timing parameters defined. For example if there can be 10 possible space lengths (e.g., 3Ts, 4Ts, 5Ts . . . 12Ts+) and 10 possible mark lengths (e.g., 3Tm, 4Tm, 5Tm . . . 12Tm+), then there can be 100 different combinations of space-to-mark lengths and 100 different combination of mark-to-space lengths. Now, also assume that four timing parameters (e.g., TSFP, TEFP, TMFP and TEER) can be defined for each combination of space-to-mark length, and four timing parameters (e.g., TSLP, TELP, TEMPP and TECP) can be defined for each combination of mark-to-space lengths. Assuming each timing parameters requires a byte to define, it would take 800 bytes to define all possible timing parameters. Now, also assume that only 128 bytes of timing memory are set aside to define such parameters (e.g., 64 bytes for space-to-mark timing parameters and 64 bytes for mark-to-space timing parameters). By allowing a user to define how the timing memory is organized, the user can specify which combinations of space-to-mark lengths and mark-to-space lengths can have unique timing parameters defined. For example, referring to FIGS. 8A and 8B, here the user has chosen to specify that unique space-to-mark timing parameters (TSFP, TEFP, TMFP and TEER) can be defined for space lengths 3Ts, 4Ts, 5Ts and 6Ts+ in combination with any of mark lengths 3Tm, 4Tm, 5Tm and 6Tm+; and that unique mark-to-space timing parameters (TSLP, TELP, TEMPP and TECP) can be defined for mark lengths 3Tm, 4Tm, 5Tm and 6Tm+ in combination with any of space lengths 3Ts, 4Ts, 5Ts and 6Ts+. For another example, referring to FIGS. 12A and 12B, here the user has chosen to specify that unique space-to-mark parameters (TSFP, TEFP, TMFP and TEER) are based only on mark length, with a different 10 possible mark lengths (3m, 4m, 5m. . . 12+m); and that unique mark-to-space parameters (TSLP, TELP, TEMPP and TECP) can be defined for 10 possible mark lengths.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Unless otherwise specified, alternate boundaries can be defined so long as the specified functions and relationships thereof are appropriately performed. Any such alternate boundaries are thus within the scope and spirit of the claimed invention.

The breadth and scope of the present invention should not be limited by any of the above-described exemplary embodiments, but should be defined only in accordance with the following claims and their equivalents.

What is claimed is:

1. A laser driver system that provides flexible write strategies, comprising:
timing memory, a portion of which is dedicated to storing space-to-mark and mark-to-space parameters that define pulses of a mark; and
means for allowing a user to specify which combinations, of total possible combinations, of space-to-mark lengths and mark-to-space lengths can have unique timing parameters defined in said portion of said timing memory dedicated to storing space-to-mark and mark-to-space timing parameters, where unique timing parameters are defined for less than the total possible combinations of space-to-mark lengths and mark-to-space lengths.

2. The system of claim 1, wherein said means comprises at least one write strategy control register that includes a plurality of bits that enable a user to specify which combinations, of total possible combinations, of space-to-mark lengths and mark-to-space lengths can have unique timing parameters defined in said portion of said timing memory dedicated to storing space-to-mark and mark-to-space timing parameters.

3. The system of claim 1, wherein said means comprises at least one write strategy control register that includes a plurality of bits that enable a user to specify how the portion of timing memory is organized.

4. The system of claim 1, where:
the unique timing parameters that can be defined for combinations of space-to-mark lengths includes at least one of TSFP, TEFP, TMFP and TEER; and
the unique timing parameters that can be defined for combinations of mark-to-space lengths includes at least one of TSLP, TELP, TEMPP and TECP.

5. A laser driver system that provides flexible write strategies, comprising:
timing memory that stores space-to-mark and mark-to-space event parameters that define at least a first pulse and a last pulse of a mark; and
at least one write strategy control register that includes a plurality of bits that are used to specify how the timing memory is organized.

6. The system of claim 5, wherein the timing memory can be organized as 4×4, 5×3 and mark-length-only arrays, and wherein the bits within the at least one write strategy control register can be used to select among the arrays.

7. The system of claim 5, wherein the write strategy control register also includes at least one bit that is used to specify either a mode-A or a mode-B timing mode.

8. The system of claim 7, wherein the at least one write strategy control register also includes at least one bit that is used to specify a modulation code.

9. The system of claim 8, wherein the at least one write strategy control register enables a selection of different combinations of timing memory organization, timing mode and modulation code.

10. The system of claim 5, wherein the at least one write strategy control register includes at least one bit that is used to specify whether a first multipulse location begins on the 1st T of a mark or on the 2nd T of a mark.

11. The system of claim 10, wherein the at least one write strategy control register includes at least one bit that is used to specify whether a first or a second modulation code is used when writing.

12. The system of claim 11, wherein the at least one write strategy control register enables a selection of:
one of at least two different ways in which timing memory is organized;
whether a first multipulse location begins on the 1st T of a mark or on the 2nd T of a mark; and
whether a first or a second modulation code is used when writing.

13. A laser driver system that provides flexible write strategies, comprising:
timing memory, a portion of which is dedicated to storing space-to-mark and mark-to-space event parameters that define pulses of a mark; and
at least one write strategy control register that includes a plurality of bits that are used to specify how the portion of timing memory is organized.

14. The system of claim 13, wherein the portion of timing memory can be organized as different arrays, and wherein the bits within the write strategy control register can be used to select among the arrays.

15. The system of claim 13, wherein the at least one write strategy control register also includes at least one bit that is used to select among different timing modes.

16. The system of claim 15, wherein the different timing modes specify where a first multipulse location begins.

17. The system of claim 15, wherein the at least one write strategy control register enables a selection of different combinations of timing memory organization and timing mode.

18. The system of claim 15, wherein the at least one write strategy control register also includes at least one bit that is used to select among different modulation codes.

19. The system of claim 18, wherein the at least one write strategy control register enables a selection of different combinations of timing memory organization, timing mode and modulation code.

20. The system of claim 13, wherein the at least one write strategy control register includes at least one bit that is used to specify where a first multipulse location begins.
